(19) United States
(12) Patent Application Publication
(10) Pub. No.: US 2009/0167185 A1
(43) Pub. Date: Jul. 2, 2009

(54) LIGHT EMITTING DIODE DEVICE AND MOBILE ELECTRONIC DEVICE USING THE SAME

(75) Inventor: KUO-HSIANG CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City, Taipei County (TW)

(21) Appl. No.: 12/191,390

(22) Filed: Aug. 14, 2008

(30) Foreign Application Priority Data
Dec. 28, 2007 (CN) 200710203535.9

(51) Int. Cl. H01J 7/44

(52) U.S. Cl. 315/56

(57) ABSTRACT

A mobile electronic device (20) includes an electrical heating element (26) and a light emitting diode device (10) installed therein. The light emitting diode device includes a temperature sensor (12) in contact with the electrical heating element, a processor (14), an electrical power source assembly (16), and a light mixer (18). The temperature sensor generates an electric signal indicating a temperature of the electrical heating element. The processor receives the electric signal from the temperature sensor, reads out the temperature of the electrical heating element, and generates a control signal varying with the temperature of the electrical heating element. The electrical power source assembly receives the control signal and supplies the light mixer with electrical power source varying with the control signal.

### BACKGROUND

1. Field of the Invention

The present invention relates to light emitting diode devices for portable electronic devices, particularly to a light emitting diode device emitting light varying with temperature, and mobile electronic device using the light emitting diode device.

2. Description of Related Art

Nowadays, mobile electronic devices, which appear attractive in various multitude colors, are highly desirable. A typical mobile electronic device, such as a mobile phone, usually has a plurality of keys and a light emitting diode device installed therein configured for illuminating the keys. However, the light emitting diode device only emits light with a single color. That is, the light emitting diode device cannot supply the mobile electronic device with colorful lighting to achieve different decorative appearances.

Therefore, a new light emitting diode device is desired in order to overcome the above-described shortcomings.

### BRIEF DESCRIPTION OF THE DRAWINGS

Many aspects of the mobile electronic device can be better understood with reference to the following drawing. The components in the drawing are not necessarily drawn to scale, the emphasis instead being placed upon clearly illustrating the principles of the mobile electronic device. Moreover, in the drawing like reference numerals designate corresponding parts throughout the several views.

FIG. 1 is a block diagram showing an arrangement of a light emitting diode device used in an electronic device.

FIG. 2 is a schematic view of a light emitting diode device used in the mobile electronic device shown in FIG. 1.

FIG. 3 is a partial cut-away view of FIG. 2 along X-X line.

### DETAILED DESCRIPTION OF THE INVENTION

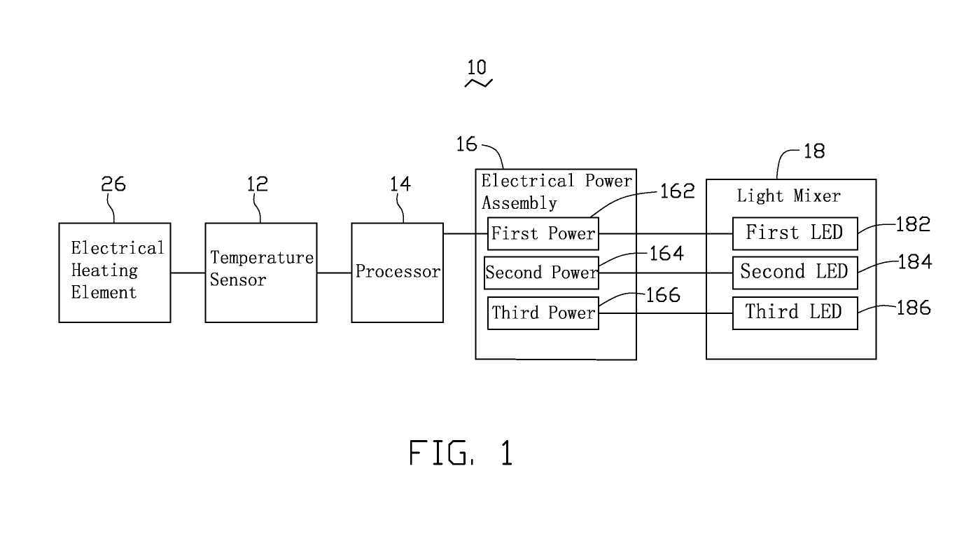

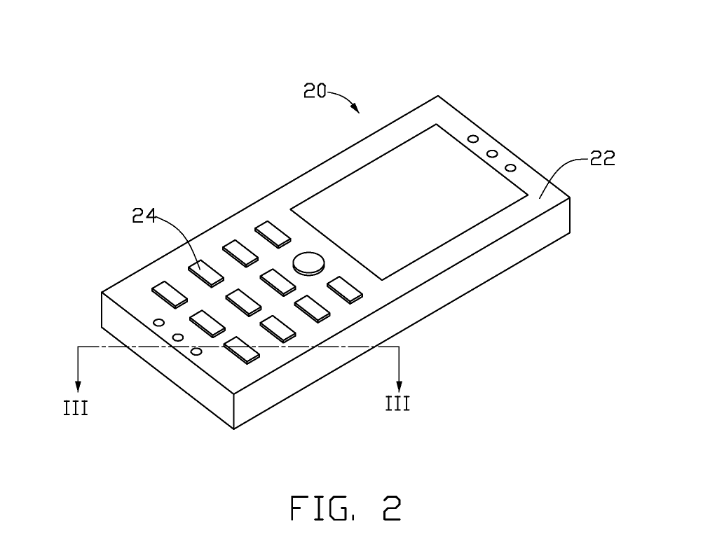

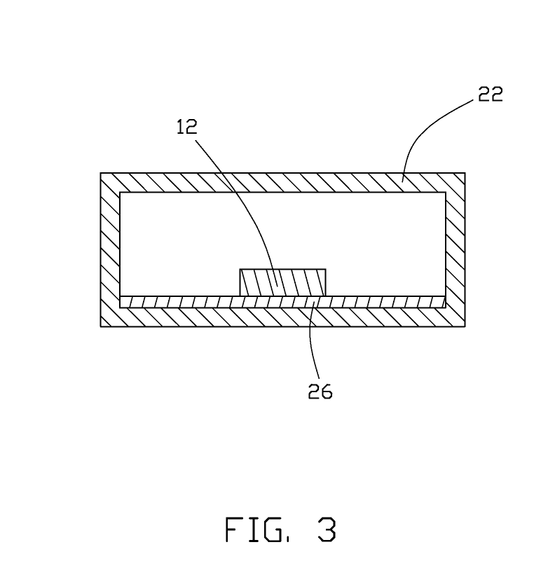

Referring to FIG. 1, FIG. 2, and FIG. 3, in a present embodiment, a light emitting diode (LED) device 10 is used in a mobile electronic device 20. The mobile device 20 includes a housing body 22, a plurality of keys 24 incorporated thereon, and an electrical heating element 26 (e.g., a printed circuit board or a central processing unit) mounted therein.

The light emitting diode device 10 includes a temperature sensor 12, a processor 14, a electrical power source assembly 16, and a light mixer 18. The temperature sensor 12, the processor 14, the electrical power source assembly 16, and the light mixer 18 are electrically connected in series.

The temperature sensor 12 is installed in the mobile device 20 and in contact with the electrical heating element 26. The temperature sensor 12 detects the temperature of the electrical heating element 26, generates an electric signal indicating the temperature of the electrical heating element, and sends the electric signal to the processor 14.

The processor 14 may have a plurality of predetermined temperature ranges stored therein. The predetermined temperature ranges define a plurality of predetermined temperature ranges. The processor 14 receives the electric signal indicating the temperature of the electrical heating element 26 from the temperature sensor 12, interprets the electric signal, and generates a control signal varying with a result of comparing the temperature of the electrical heating element 26 with the predetermined temperature ranges. The control signal is corresponds to one of the predetermined temperature ranges, in which the temperature of the electrical heating element 26 falls in.

The electrical power source assembly 16 includes a first power source 162, a second power source 164, and a third power source 166, which are all connected to the processor 14 and controlled by the processor 14. Thus, the control signal generated by the processor 14 may include three output signals, determining the output voltages of the first power source 162, the second power source 164, and the third power source 166, respectively.

The light mixer 18 includes a first LED 182 emitting blue light, a second LED 184 emitting green light, and a third LED 186 emitting red light, which are electrically connected to the first power source 162, the second power source 164, and the third power source 166, respectively. Thus, the first power source 162, the second power source 164, and the third power source 166 independently power the first LED 182, the second LED 184, and the third LED 186. The light emitted by the first LED 182, the second LED 184, and the third LED 186 can be mixed together in varying intensities. Thus, a mixed light can be obtained with any desired color. The light mixer 18 may be installed in the housing body 22 of the mobile device 20, advantageously, under the keys 24 of the mobile device 20.

In operation, the temperature sensor 12 detects the temperature of the electrical heating element 26, generates an electric signal indicating the temperature of the electrical heating element 26, and sends the electric signal to the processor 14. The processor 14 receives the electrical signal, identifies the information of the temperature indicated in the electrical signal, and compares the temperature value of the electrical heating element 26 with the predetermined temperature ranges stored in the processor 14.

The predetermined temperature ranges may be determined by characters of the electrical heating element 26. For example, in the present embodiment, if the working temperature of the electrical heating element 26 is in a range from 30° C. to 80° C., the predetermined temperature ranges may be 30° C., 40° C., 50° C., 60° C., 70° C., and 80° C. The predetermined temperature ranges may define five predetermined temperature ranges, which include a first section in a range from 30° C. to 40° C., a second section in a range from 40° C. to 50° C., a third section in a range from 50° C. to 60° C., a fourth section in a range from 60° C. to 70° C., and a fifth section in a range from 70° C. to 80° C. The first section, the second section, the third section, the fourth section, and the fifth section may be respectively indicated by blue light, yellow light, green light, orange light, and red light.

If the temperature of the electrical heating element 26 is 55° C., the processor 14 may determine which range the temperature of the electrical heating element 26 falls in by comparing the temperature of the electrical heating element 26 with the predetermined temperature ranges stored in the processor 14. The processor 26 then generates an output signal to activate the second power source 164 to supply the second LED 184 with the electrical power source and the second LED 184 emits light, thereby coloring the keys 24 and/or the housing body 22 with green light.

As such, the color of the light emitted by the light mixer 18 can be varied with the temperature of the electrical heating element 26. Thus, the housing body 22 of the mobile device 20 can be have varying color appearance, in variation of the temperature of the electrical heating element 26.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile electronic device, comprising:
an electrical heating element installed therein; and
a light emitting diode device comprising:
a temperature sensor in contact with the electrical heating element, the temperature sensor generating an electric signal indicating a temperature of the electrical heating element;
a processor receiving the electric signal from the temperature sensor, reading out the temperature of the electrical heating element, and generating a control signal varying with the temperature of the electrical heating element;
an electrical power source assembly receiving the control signal; and
a light mixer electronically connected to the electrical power source assembly, the electrical power source assembly supplying the light mixer with electrical power source varying with the control signal.

2. The mobile electronic device as claimed in claim 1, wherein the processor may have a plurality of predetermined temperature ranges stored therein, the processor generating the control signal varying with a result of comparing the temperature of the electrical heating element with the predetermined temperature ranges stored in the processor.

3. The mobile electronic device as claimed in claim 1, wherein the light mixer includes a blue light emitting diode device emitting blue light, a green light emitting diode device emitting green light, and a red light emitting device emitting red light.

4. The mobile electronic device as claimed in claim 3, wherein the electrical power source assembly includes a first power source driving the blue light emitting diode device, a second power source driving the green light emitting diode device, and a third power source driving the red light emitting diode device.

5. The mobile electronic device as claimed in claim 4, wherein the control signal includes three output signals respectively driving the first power source, the second power source, and the third power source.

6. A light emitting diode device for a mobile electronic device having an electrical heating element, comprising:
a temperature sensor in contact with the electrical heating element, the temperature sensor generating an electric signal indicating a temperature of the electrical heating element;
a processor receiving the electric signal from the temperature sensor, reading out the temperature of the electrical heating element, and generating a control signal varying with the temperature of the electrical heating element;
an electrical power source assembly receiving the control signal; and
a light mixer electronically connected to the electrical power source assembly, the electrical power source assembly supplying the light mixer with electrical power source varying with the control signal.

7. The light emitting diode device as claimed in claim 6, wherein the processor may have a plurality of predetermined temperature ranges stored therein, the processor generating the control signal varying with a result of comparing the temperature of the electrical heating element with the predetermined temperature ranges stored in the processor.

8. The light emitting diode device as claimed in claim 6, wherein the light mixer includes a blue light emitting diode device emitting blue light, a green light emitting diode device emitting green light, and a red light emitting device emitting red light.

9. The light emitting diode device as claimed in claim 8, wherein the electrical power source assembly includes a first power source driving the blue light emitting diode device, a second power source driving the green light emitting diode device, and a third power source driving the red light emitting diode device.

10. The light emitting diode device as claimed in claim 9, wherein the control signal includes three output signals respectively driving the first power source, the second power source, and the third power source.
